(19) United States
(12) Patent Application Publication
(10) Pub. No.: US 2020/0349829 A1
(43) Pub. Date: Nov. 5, 2020

(54) SYSTEM AND METHOD FOR ALERTING, RECORDING AND TRACKING AN ASSAILANT

(71) Applicant: MOBILE SOFTWARE AS, Gjoevik (NO)

(72) Inventor: Rich Larsen, West Chester, PA (US)

(73) Assignee: MOBILE SOFTWARE AS, Gjoevik (NO)

(21) Appl. No.: 16/561,316

(22) Filed: Sep. 5, 2019

Related U.S. Application Data
(60) Provisional application No. 62/727,106, filed on Sep. 5, 2018.

(51) Int. Cl. G08B 25/01; H04N 7/18; H04M 1/725; H04W 4/029

(52) U.S. Cl. CPC G08B 25/016; H04W 4/029; H04M 1/72538; H04N 7/188

(57) ABSTRACT

Systems and methods are provided for alerting one or more third party individuals that a user has activated an alarm. The method includes creating a profile for a first user with a digital application, using a graphical user interface coupled to a first electronic device, designating a method for triggering the alarm, triggering the alarm, notifying one or more second users on one or more second electronic devices that the alarm has been triggered, recording environmental data using one or more sensors coupled to the first electronic device, and sending the recording environmental data to the one or more second electronic devices.

### CROSS REFERENCE TO RELATED APPLICATION

This application is related to and claims the benefit of U.S. Provisional Patent Application Ser. No. 62/727,106 filed Sep. 5, 2018 titled “System and Method for Alerting, Recording and Tracking an Assailant,” which is incorporated by reference herein in its entirety for all purposes.

### FIELD OF THE EMBODIMENTS

This invention relates to mobile safety systems and, in particular, to a mobile safety, recording, and tracking system configured to send data to one or more third parties in the event that an alarm is triggered.

### BACKGROUND OF THE EMBODIMENTS

When traveling alone, many events can happen in which immediately contacting one or more people and letting those people know where a person is may prevent a situation from escalating into something more severe. It would also be beneficial to let those one or more people see and/or hear what is transpiring.

With the prevalence of mobile electronic devices having Internet connectivity, a system and method of sending an alarm with video and audio information pertaining to a user's present circumstances is thus needed.

Examples of related art are described below:

U.S. Pat. No. 8,831,677 generally describes all-in-one wireless mobile telecommunication devices, methods and systems providing greater customer-control, instant-response anti-fraud/anti-identity theft protections with instant alarm, messaging and secured true-personal identity verifications for numerous registered customers/users, with biometrics and PIN security, operating with manual, touch-screen and/or voice-controlled commands, achieving secured rapid personal/business e-banking, e-commerce, accurate transactional monetary control and management, having interactive audio-visual alarm/reminder preventing fraudulent usage of legitimate physical and/or virtual credit/debit cards, with checks anti-forgery means, curtailing medical/health/insurance frauds/identity thefts, having integrated cellular and/or satellite telephonic/internet and multi-media means, equipped with language translations, GPS navigation with transactions tagging, currency converters, with or without NFC components, minimizing potential airport risks/mishaps, providing instant aid against school bullying, kidnapping, car-napping and other crimes, applicable for secured military/immigration/law enforcements, providing guided warning/rescue during emergencies and disasters.

U.S. Pat. No. 8,994,530 generally describes means for initiating a distress signal by knocking over an object, such as a table, decorative piece, furniture, etc., that includes a built-in or embedded safety device. When the safety device senses substantial movement (i.e., toppling) of the object, the safety device transmits a distress signal to third-party responders, and also can initiate various events in the environment surrounding the object to deter, delay, or disrupt a perpetrator.

U.S. Pat. No. 9,030,292 generally describes a system and device for providing services to a secure facility. The system includes a kiosk with a processor, display, speaker, microphone, and a camera, and the kiosk communicates with a server that includes a server processor, a network interface unit, and a computer memory. The kiosk receives communications and transmits audio and video of the communications to the server via an internet connection, and the server records the audio and video and transmits the audio and video to a destination. The kiosk is configured to authenticate the identity of a user by verifying a personal identification number entered by the user and also performing one or more of a facial recognition via the camera or a biometric voice recognition via the microphone. The kiosk provides access to services including internet services, text-based messaging, tele-medical services, religious and educational materials, commissary ordering, and entertainment.

U.S. Pat. No. 9,183,560 generally describes a reality alternative to our physical reality, named the Expandaverse, that includes multiple digital realities that may be continuously created, broadcast, accessed, and used interactively. In what we call an Alternate Reality Teleportal Machine (ARTPM), some elements of the digital reality(ies) can be implemented using and providing functions that include: devices, architectures, processing, sensors, translation, speech recognition, remote controls, subsidiary devices usage, virtual Teleportals on alternate devices, presence, shared planetary life spaces, constructed digital realities, reality replacements, filtered views, data retrieval in constructed views, alternate realities machine(s), multiple identities, directories, controlled boundaries, life space metrics, boundaries switching, property protection, publishing/broadcasting, digital events, events location/joining, revenues, utility(ies), infrastructure, services, devices management, business systems, applications, consistent customizable user interface, active knowledge, optimizations, alerts, reporting, dashboards, switching to best, marketing and sales systems, improvement systems, user chosen goals, user management, governances, digital freedom from dictatorships, photography, and entertainment.

U.S. Pat. No. 9,225,701 generally describes systems and methods for determining whether a communication session is authorized. In some aspects, a method includes initiating a communication session between a first user and a second user, and obtaining an identity attribute associated with a third user engaged in the communication session. The method also includes determining whether the third user is the first user, the second user, or an unauthorized user based on the obtained identity attribute. The method also includes determining whether the communication session is authorized based on whether the third user is determined to be the first user, the second user, or the unauthorized user.

U.S. Pat. No. 9,443,415 generally describes a method for disseminating information regarding a problem and administering medical interventions comprises providing a mobile device wirelessly connectable to a network, receiving and storing contact information corresponding to a designated list of information recipients, receiving, via the mobile device and via the wireless trigger transmitting to the mobile device, a signal from a user indicating the problem, receiving, via the mobile device, information regarding the problem, transmitting an indication of the problem to a rescue clearinghouse via the network, prompting a participant of the rescue clearinghouse, different from the user, to make a decision about a course of action regarding the problem, and at least one of transmitting the information regarding the problem to the information recipients from the designated list and transmitting the information regarding the problem to a government rescue organization, based at least in part on the decision.

U.S. Patent Publication No. 2012/0069131 generally describes a reality alternative to our physical reality, named the Expandaverse, that includes multiple digital realities that may be continuously created, broadcast, accessed, and used interactively. In what we call an Alternate Reality Teleportal Machine (ARTPM), some elements of the digital reality(ies) can be implemented using and providing functions that include: devices, architectures, processing, sensors, translation, speech recognition, remote controls, subsidiary devices usage, virtual Teleportals on alternate devices, presence, shared planetary life spaces, constructed digital realities, reality replacements, filtered views, data retrieval in constructed views, alternate realities machine(s), multiple identities, directories, controlled boundaries, life space metrics, boundaries switching, property protection, publishing/broadcasting, digital events, events location/joining, revenues, utility(ies), infrastructure, services, devices management, business systems, applications, consistent customizable user interface, active knowledge, optimizations, alerts, reporting, dashboards, switching to □best□, marketing and sales systems, improvement systems, user chosen goals, user management, governances, digital freedom from dictatorships, photography, and entertainment.

U.S. Patent Publication No. 2012/0262271 generally describes a system and device for providing services to a secure facility. The system includes a kiosk with a processor, display, speaker, microphone, and a camera, and the kiosk communicates with a server that includes a server processor, a network interface unit, and a computer memory. The kiosk receives communications and transmits audio and video of the communications to the server via an internet connection, and the server records the audio and video and transmits the audio and video to a destination. The kiosk is configured to authenticate the identity of a user by verifying a personal identification number entered by the user and also performing one or more of a facial recognition via the camera or a biometric voice recognition via the microphone. The kiosk provides access to services including internet services, text-based messaging, tele-medical services, religious and educational materials, commissary ordering, and entertainment.

U.S. Patent Publication No. 2012/0319840 generally describes means for initiating a distress signal by knocking over an object, such as a table, decorative piece, furniture, etc., that includes a built-in or embedded safety device. When the safety device senses substantial movement (i.e., toppling) of the object, the safety device transmits a distress signal to third-party responders, and also can initiate various events in the environment surrounding the object to deter, delay, or disrupt a perpetrator.

U.S. Patent Publication No. 2012/0319841 generally describes means for initiating a distress signal by knocking over an object, such as a table, decorative piece, furniture, etc., that includes a built-in or embedded safety device. When the safety device senses substantial movement (i.e., toppling) of the object, the safety device transmits a distress signal to third-party responders, and also can initiate various events in the environment surrounding the object to deter, delay, or disrupt a perpetrator.

U.S. Patent Publication No. 2012/0319842 generally describes means for initiating a distress signal by knocking over an object, such as a table, decorative piece, furniture, etc., that includes a built-in or embedded safety device. When the safety device senses substantial movement (i.e., toppling) of the object, the safety device transmits a distress signal to third-party responders, and also can initiate various events in the environment surrounding the object to deter, delay, or disrupt a perpetrator.

U.S. Patent Publication No. 2013/0229281 generally describes means for initiating a distress signal by knocking over an object, such as a table, decorative piece, furniture, etc., that includes a built-in or embedded safety device. When the safety device senses substantial movement (i.e., toppling) of the object, the safety device transmits a distress signal to third-party responders, and also can initiate various events in the environment surrounding the object to deter, delay, or disrupt a perpetrator.

U.S. Patent Publication No. 2013/0234851 generally describes means for tracking the status of multiple mobile devices at a central safety device, wherein the safety device is embedded or built-into an object, such as a table, decorative piece, furniture, etc. The status of the mobile devices is shown on a display on the object, and various safety protocols can be initiated by the safety device.

U.S. Patent Publication No. 2013/0263227 generally describes systems and methods for determining whether a communication session is authorized. In some aspects, a method includes initiating a communication session between a first user and a second user, and obtaining an identity attribute associated with a third user engaged in the communication session. The method also includes determining whether the third user is the first user, the second user, or an unauthorized user based on the obtained identity attribute. The method also includes determining whether the communication session is authorized based on whether the third user is determined to be the first user, the second user, or the unauthorized user.

U.S. Patent Publication No. 2014/0162598 generally describes all-in-one wireless mobile telecommunication devices, methods and systems providing greater customer-control, instant-response anti-fraud/anti-identity theft protections with instant alarm, messaging and secured true-personal identity verifications for numerous registered customers/users, with biometrics and PIN security, operating with manual, touch-screen and/or voice-controlled commands, achieving secured rapid personal/business e-banking, e-commerce, accurate transactional monetary control and management, having interactive audio-visual alarm/reminder preventing fraudulent usage of legitimate physical and/or virtual credit/debit cards, with cheques anti-forgery means, curtailing medical/health/insurance frauds/identity thefts, having integrated cellular and/or satellite telephonic/internet and multi-media means, equipped with language translations, GPS navigation with transactions tagging, currency converters, with or without NFC components, minimizing potential airport risks/mishaps, providing instant aid against school bullying, kidnapping, car-napping and other crimes, applicable for secured military/immigration/law enforcements, providing guided warning/rescue during emergencies and disasters.

U.S. Patent Publication No. 2014/0218537 generally describes a method for disseminating information regarding a problem and administering medical interventions comprises providing a mobile device wirelessly connectable to a network, receiving and storing contact information corresponding to a designated list of information recipients, receiving, via the mobile device, a signal from a user indicating the problem, receiving, via the mobile device, information regarding the problem, transmitting an indication of the problem to a rescue clearinghouse via the network, prompting a participant of the rescue clearinghouse, different from the user, to make a decision about a course of action regarding the problem, and at least one of transmitting the information regarding the problem to the information recipients from the designated list and transmitting the information regarding the problem to a government rescue organization, based at least in part on the decision.

U.S. Patent Publication No. 2014/0365574 generally describes a non-transitory is described being operably coupled to a processor and storing processor executable instructions which when executed by the processor cause the processor to receive first information indicative of a school incident report by a reporter. The first information of the school incident report indicating at least a type of incident which violates one or more school policies and a location of the incident. The processor then selects one or more recipients from a group of notification recipients based on the first information. The processor then generates a notification indicative of the type of incident and the location of the incident. The processor then transmits a signal via a communications network indicative of the notification.

U.S. Patent Publication No. 2015/0002293 generally describes a method for disseminating information regarding a problem and administering medical interventions comprises providing a mobile device wirelessly connectable to a network, receiving and storing contact information corresponding to a designated list of information recipients, receiving, via the mobile device, a signal from a user indicating the problem, receiving, via the mobile device, information regarding the problem, transmitting an indication of the problem to a rescue clearinghouse via the network, prompting a participant of the rescue clearinghouse, different from the user, to make a decision about a course of action regarding the problem, and at least one of transmitting the information regarding the problem to the information recipients from the designated list and transmitting the information regarding the problem to a government rescue organization, based at least in part on the decision.

U.S. Patent Publication No. 2015/0137972 generally describes a method for disseminating information regarding a problem and administering medical interventions comprises providing a mobile device wirelessly connectable to a network, receiving and storing contact information corresponding to a designated list of information recipients, receiving, via the mobile device and via the wireless trigger transmitting to the mobile device, a signal from a user indicating the problem, receiving, via the mobile device, information regarding the problem, transmitting an indication of the problem to a rescue clearinghouse via the network, prompting a participant of the rescue clearinghouse, different from the user, to make a decision about a course of action regarding the problem, and at least one of transmitting the information regarding the problem to the information recipients from the designated list and transmitting the information regarding the problem to a government rescue organization, based at least in part on the decision.

U.S. Patent Publication No. 2016/0071399 generally describes a personal security system that continually monitors audio from any microphone accessible from a computer or mobile phone for keys, identifies keys emitted by a user and if found, issues an alert. May also monitor movement to aid in event detection. Audio monitoring may search for keys in a personalized manner to minimize false positives and may work on low power devices in the background to continually provide security, even if a computer is locked. May transmit alerts via a data network, or voice network. The alerts may be sent to users, devices, security or medical entities to provide personal safety and security. May also be utilized for persons unable to physically manipulate their phone or computer, during or after an assault, or medical emergency. May also be utilized to improve safety when moving between locations, to improve the safety of a driver or a passenger of a vehicle.

U.S. Patent Publication No. 2016/0078281 generally describes systems and methods for determining whether a communication session is authorized. In some aspects, a method includes initiating a communication session between a first user and a second user, and obtaining an identity attribute associated with a third user engaged in the communication session. The method also includes determining whether the third user is the first user, the second user, or an unauthorized user based on the obtained identity attribute. The method also includes determining whether the communication session is authorized based on whether the third user is determined to be the first user, the second user, or the unauthorized user.

U.S. Patent Publication No. 2016/0086108 generally describes a reality alternative to our physical reality, named the Expandaverse, that includes multiple digital realities that may be continuously created, broadcast, accessed, and used interactively. In what we call an Alternate Reality Teleportal Machine (ARTPM), some elements of the digital reality(ies) can be implemented using and providing functions that include: devices, architectures, processing, sensors, translation, speech recognition, remote controls, subsidiary devices usage, virtual Teleportals on alternate devices, presence, shared planetary life spaces, constructed digital realities, reality replacements, filtered views, data retrieval in constructed views, alternate realities machine(s), multiple identities, directories, controlled boundaries, life space metrics, boundaries switching, property protection, publishing/broadcasting, digital events, events location/joining, revenues, utility(ies), infrastructure, services, devices management, business systems, applications, consistent customizable user interface, active knowledge, optimizations, alerts, reporting, dashboards, switching to best, marketing and sales systems, improvement systems, user chosen goals, user management, governances, digital freedom from dictatorships, photography, and entertainment.

International Patent Publication No. WO2012067640A1 generally describes wireless mobile devices, methods and systems dedicated to achieve greater customer control for protection against identity fraud/theft and medical/health insurance fraud, able to curtail any and/or most or all unauthorized and fraudulent usage of legitimate a person's identity.

International Patent Publication No. WO2016040152A1 generally describes a personal security system that continually monitors audio from any microphone accessible from a computer or mobile phone for keys, identifies keys emitted by a user and if found, issues an alert. May also monitor movement to aid in event detection. Audio monitoring may search for keys in a personalized manner to minimize false positives and may work on low power devices in the background to continually provide security, even if a computer is locked. May transmit alerts via a data network, or voice network. The alerts may be sent to users, devices, security or medical entities to provide personal safety and security. May also be utilized for persons unable to physically manipulate their phone or computer, during or after an assault, or medical emergency. May also be utilized to improve safety when moving between locations, to improve the safety of a driver or a passenger of a vehicle.

None of the art described above addresses all of the issues that the present invention does.

### SUMMARY OF THE EMBODIMENTS

According to an aspect of the present invention, a method for alerting one or more third party individuals that a user has activated an alarm is provided. The method includes creating a profile for a first user with a digital application, using a graphical user interface coupled to a first electronic device, designating a method for triggering the alarm, triggering the alarm, notifying one or more second users on one or more second electronic devices that the alarm has been triggered, recording environmental data using one or more sensors coupled to the first electronic device, and sending the recording environmental data to the one or more second electronic devices.

It is an object of the present invention to provide the method for alerting the one or more third party individuals that the first user has activated the alarm, wherein the method further includes selecting the one or more second users using the graphical user interface.

It is an object of the present invention to provide the method for alerting the one or more third party individuals that the first user has activated the alarm, wherein the one or more sensors are selected from the group consisting of: a microphone; and a camera.

It is an object of the present invention to provide the method for alerting the one or more third party individuals that the first user has activated the alarm, wherein the environmental data includes one or more audio recordings.

It is an object of the present invention to provide the method for alerting the one or more third party individuals that the first user has activated the alarm, wherein the environmental data includes one or more video recordings.

It is an object of the present invention to provide the method for alerting the one or more third party individuals that the first user has activated the alarm, wherein the method further includes, when the alarm is triggered, sending a live video stream from the first electronic device to the one or more second electronic devices.

It is an object of the present invention to provide the method for alerting the one or more third party individuals that the first user has activated the alarm, wherein the method further includes determining a location of the first electronic device.

It is an object of the present invention to provide the method for alerting the one or more third party individuals that the first user has activated the alarm, wherein the method further includes, when the alarm is triggered, sending the location of the first electronic device to the one or more second electronic devices.

It is an object of the present invention to provide the method for alerting the one or more third party individuals that the first user has activated the alarm, wherein the first electronic device is a smart phone.

It is an object of the present invention to provide the method for alerting the one or more third party individuals that the first user has activated the alarm, wherein the method further includes sending the recorded environmental data to one or more remote servers.

According to another aspect of the present invention, a system for alerting one or more third party individuals that a first user has activated an alarm is provided. The system includes a first electronic device, including a memory configured to store a digital application, a processor configured to run the digital application, a graphical user interface configured to enable a first user to create a profile with the digital application, designate a method for triggering the alarm, and trigger the alarm, one or more sensors coupled configured to record environmental data, and a transceiver configured to notify one or more second users on one or more second electronic devices that the alarm has been triggered, and send the recording environmental data to the one or more second electronic devices. The system further includes the one or more second electronic devices.

It is an object of the present invention to provide the system for alerting the one or more third party individuals that the first user has activated the alarm, wherein the graphical user interface is further configured to enable the first user to select the one or more second users.

It is an object of the present invention to provide the system for alerting the one or more third party individuals that the first user has activated the alarm, wherein the one or more sensors are selected from the group consisting of: a microphone; and a camera.

It is an object of the present invention to provide the system for alerting the one or more third party individuals that the first user has activated the alarm, wherein the environmental data includes one or more audio recordings.

It is an object of the present invention to provide the system for alerting the one or more third party individuals that the first user has activated the alarm, wherein the environmental data includes one or more video recordings.

It is an object of the present invention to provide the system for alerting the one or more third party individuals that the first user has activated the alarm, wherein the transceiver is further configured to, when the alarm is triggered, send a live video stream from the first electronic device to the one or more second electronic devices.

It is an object of the present invention to provide the system for alerting the one or more third party individuals that the first user has activated the alarm, wherein the processor is further configured to determine a location of the first electronic device.

It is an object of the present invention to provide the system for alerting the one or more third party individuals that the first user has activated the alarm, wherein the transceiver is further configured to, when the alarm is triggered, send the location of the first electronic device to the one or more second electronic devices.

It is an object of the present invention to provide the system for alerting the one or more third party individuals that the first user has activated the alarm, wherein the first electronic device is a smart phone.

It is an object of the present invention to provide the system for alerting the one or more third party individuals that the first user has activated the alarm, wherein the system further includes one or more remote servers, and wherein the transceiver is further configured to send the recorded environmental data to the one or more remote servers.

### BRIEF DESCRIPTION OF THE DRAWINGS

FIG. 1 show a method for alerting one or more third parties of an alarm triggered by a user and sending data pertaining to that alarm to the one or more third parties, according to an embodiment of the present invention.

FIG. 2 show a method for alerting one or more third parties of an alarm triggered by a user and sending data pertaining to that alarm to the one or more third parties, according to an embodiment of the present invention.

FIG. 3 show a method for alerting one or more third parties of an alarm triggered by a user and sending data pertaining to that alarm to the one or more third parties, according to an embodiment of the present invention.

FIG. 4 shows a system for alerting one or more third parties of an alarm triggered by a user and sending data pertaining to that alarm to the one or more third parties, according to an embodiment of the present invention.

FIG. 5 shows a screenshot of a screen requesting a phone number be input using a digital application configured to alert one or more third parties of an alarm being triggered by a user and sending data pertaining to that alarm to the one or more third parties, according to an embodiment of the present invention.

FIG. 6 shows a screenshot of an alarm key phrase test using a digital application configured to alert one or more third parties of an alarm being triggered by a user and sending data pertaining to that alarm to the one or more third parties, according to an embodiment of the present invention.

FIG. 7 shows a screenshot of a screen showing a geolocation using a digital application configured to alert one or more third parties of an alarm being triggered by a user and sending data pertaining to that alarm to the one or more third parties, according to an embodiment of the present invention.

FIG. 8 shows a screenshot of a screen showing which individuals are receiving a location and a video stream of a user using a digital application configured to alert one or more third parties of an alarm being triggered by a user and sending data pertaining to that alarm to the one or more third parties, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

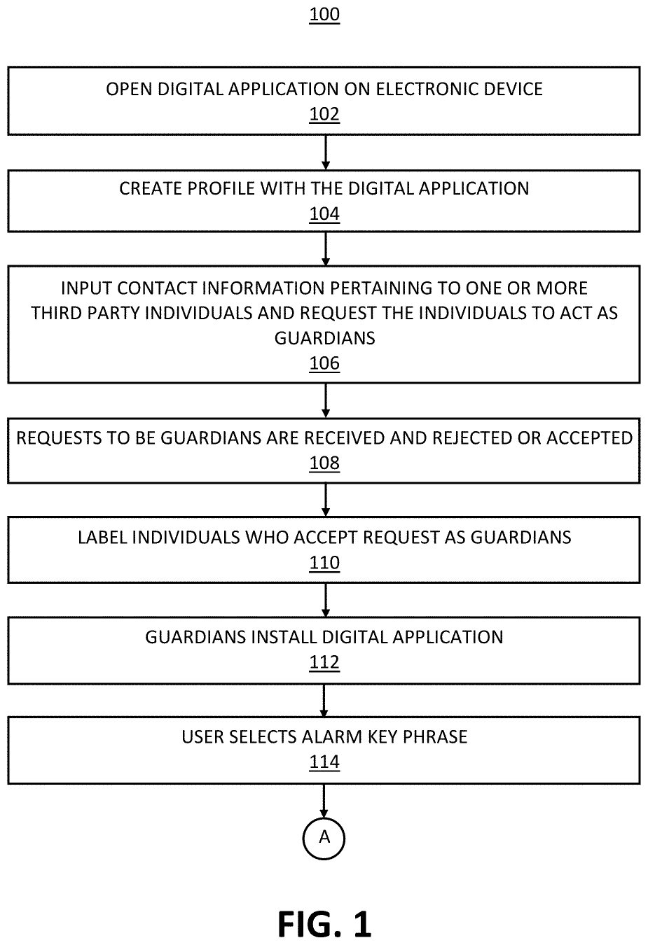

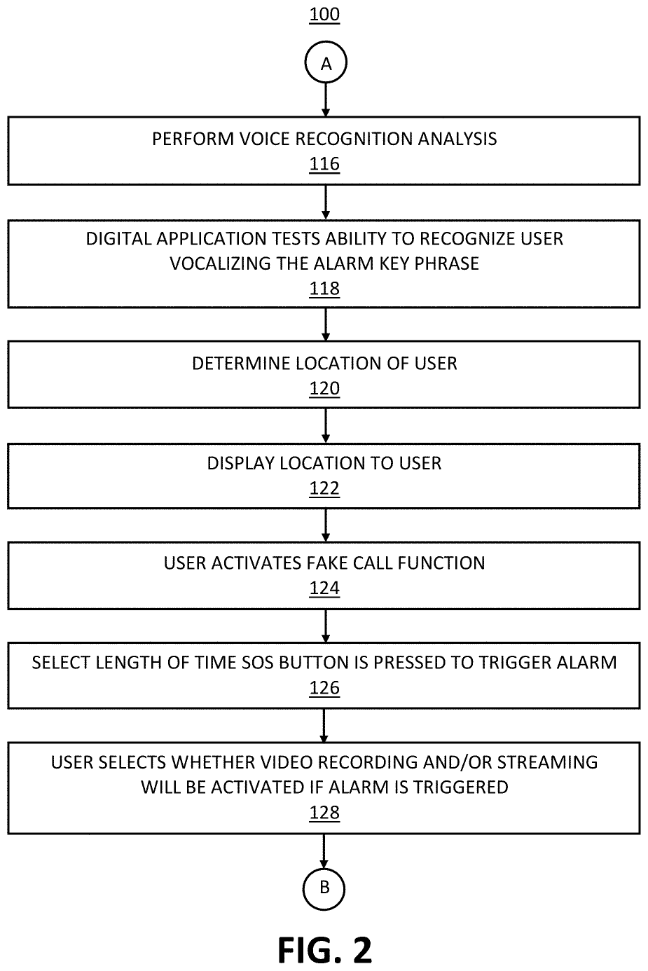

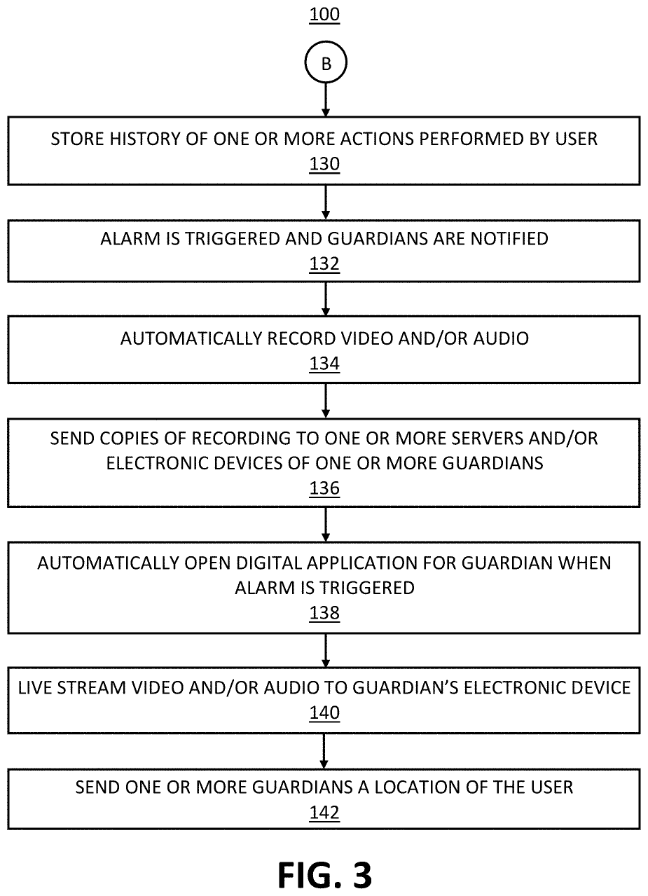

Referring now to FIGS. 1-3, a method 100 for alerting one or more third parties of an alarm triggered by a user and sending data pertaining to that alarm to the one or more third parties is illustratively depicted, in accordance with an embodiment of the present invention.

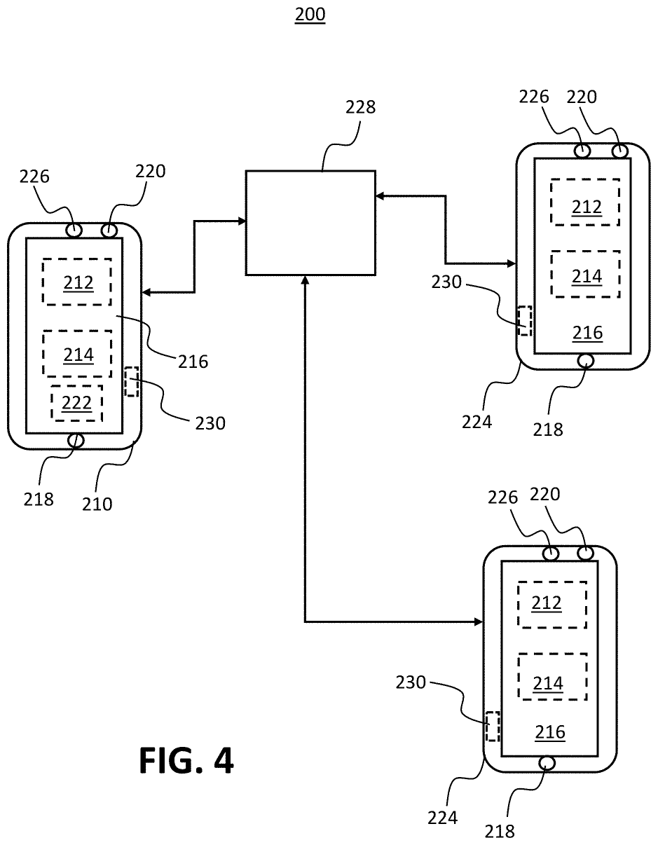

At step 102, the user opens a digital application on a digital electronic device 210 (as shown in system 200 of FIG. 4). According to an embodiment, the electronic device 210 is a smart phone. However, it is noted that, according to various embodiments of the present invention, any suitable mobile electronic device may be used while maintaining the spirit of the present invention. According to an embodiment, the digital application is downloaded onto the electronic device 210. According to an embodiment, the electronic device 210 includes a processor 212, a memory 214, an audio recording device 218 (e.g., a microphone), a video recording device 220 (e.g., a camera), a graphical user interface 216, and/or any other suitable components.

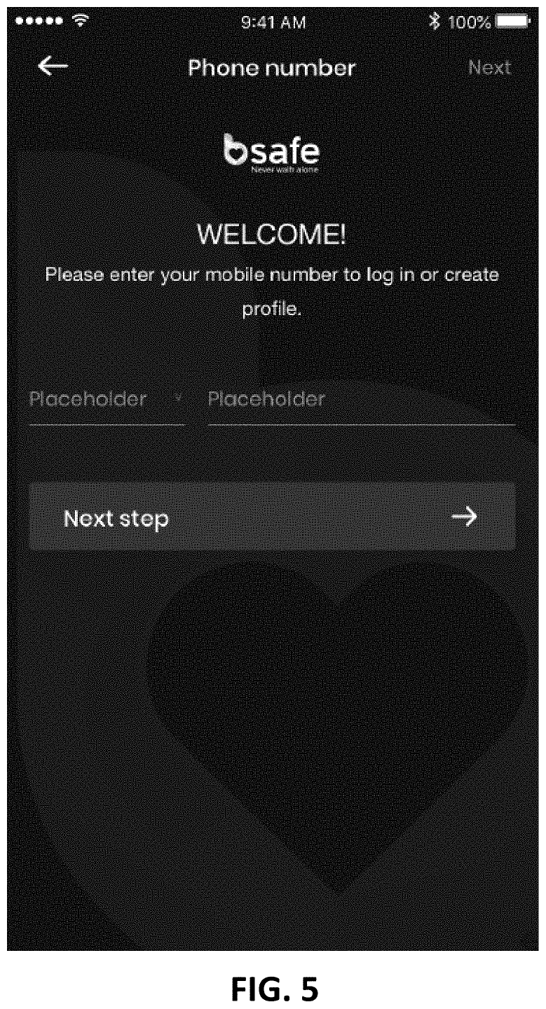

At step 104, the user creates a profile with the digital application using the graphical user interface 216. According to an embodiment, the creation of the profile includes one or more steps to confirm the profile will be associated with the electronic device 210. For example, according to an embodiment, the creation of the profile includes inputting a phone number associated with the electronic device 210 (as shown in FIG. 5).

According to an embodiment, the creation of the profile includes inputting data into the digital application that pertains to the identity of the user. This data may include, e.g., the user's name, email address, phone number, physical address, and/or any other suitable piece of data pertaining to the identity of the user. According to an embodiment, the creation of the profile includes inputting an image of the user.

At step 106, the user inputs contact information pertaining to one or more third party individuals and requests that these individuals act as emergency contacts through the digital application (hereinafter referred to as “guardians”). According to an embodiment, in the event that an alarm is triggered by the user, data pertaining to the user's location and/or video and/or audio recordings or live streams are sent to the one or more guardians. According to an embodiment, at step 108, each of the one or more third party individuals receives the request on his/her electronic device 224 to become a guardian and each of the one or more third party individuals accepts or rejects the request to become one or more user's guardians. According to an embodiment, at step 110, any of the one or more third party individuals who accept the request to be one of the user's guardians is then labelled as a guardian for the user. According to an embodiment, the user may receive requests from one or more third party individuals to become a guardian for the one or more third party individuals.

According to an embodiment, the guardians, at step 112, install the digital application on one or more electronic devices 224 accessible to the one or more guardians. According to an embodiment, to receive an alert from the user, the one or more guardians need not install the digital application. According to an embodiment, in order to receive the request to be a guardian, a user must have first already installed the digital application and created a profile.

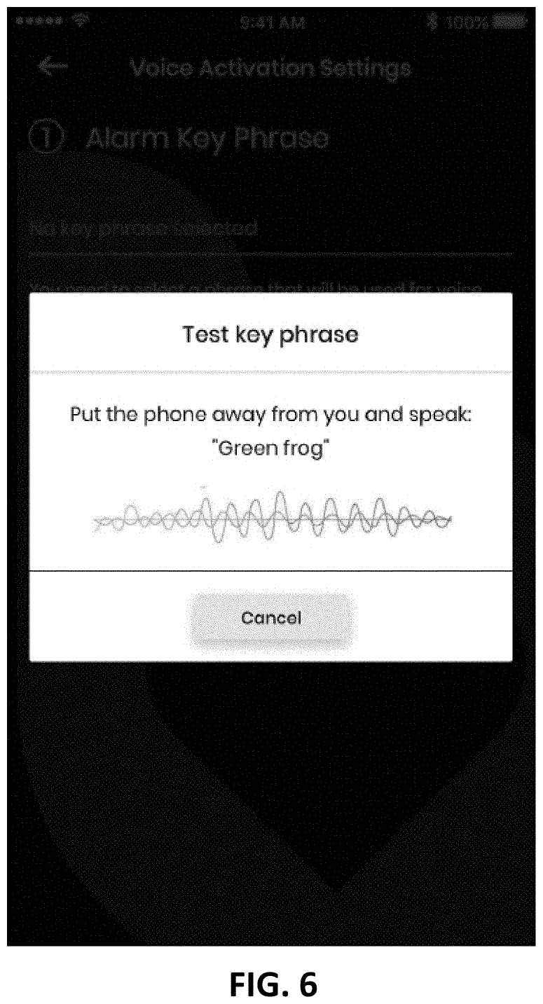

According to an embodiment, the user, at step 114, selects an alarm key phrase. The alarm key phrase is used to activate the alarm in the event that the alarm key phrase is picked up on a microphone 218 coupled to the user's electronic device 210. According to an embodiment, the user manually inputs an alarm key phrase using the microphone 218 and/or the graphical user interface 216. According to an embodiment, the user selects the alarm key phrase, using the graphical user interface 216 from a list of possible alarm key phrases. According to an embodiment, the digital application, in conjunction with the microphone 218 and the processor 212 and memory 214, at step 116, performs voice recognition analysis to determine when the user is speaking. According to an embodiment, the digital application, at step 118, tests the user's electronic device's ability to recognize the alarm key phrase when spoken by the user. According to an embodiment, the test includes requesting that the user repeat the alarm key phrase until the electronic device is able to recognize that the user is vocalizing the alarm key phrase. For example, the digital application may prompt the user to “put the phone away from you and speak” the alarm key phrase (as shown in FIG. 6). According to an embodiment, due to the voice recognition, the digital application will respond only if it determines that the alarm key phrase has been spoken by the user, preventing unrecognized people from prompting the alarm key phrase.

At step 120, the digital application connects to any geolocation software and/or hardware 222 coupled to the user's electronic device, determining a location of the user's electronic device 210 and the user, if the user is in possession of the electronic device 210. At step 122, the digital application displays to the user the user's location on a display and/or graphical user interface 216 coupled to the user's electronic device 210.

At step 124, the user activates a fake call function on the digital application. According to an embodiment, the fake call function causes the user's electronic device 210 to appear as though there is an active call. According to an embodiment, the fake call feature may cause the phone to ring, dial, display the fake call on the display 216 of the user's electronic device, output prerecorded voice through a speaker 226 of the user's electronic device, and/or any other functions performed by the user's electronic device 210 during the course of a typical phone call. The fake call function of the digital application enables the user to appear as though the user is on the phone, giving the user the appearing of being in current contact with at least one other person who would be able to hear anything that is transpiring in the direct vicinity of the user.

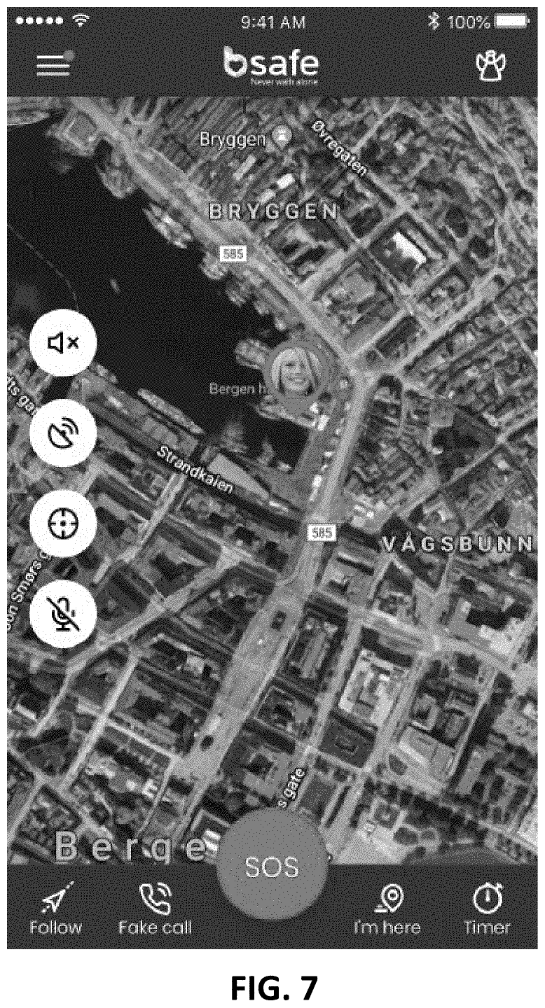

According to an embodiment, the digital application displays an alarm button (herein referred to as the “alarm button” or “SOS button”) on the graphical user interface 216 of the user's electronic device 210. The SOS button may be on the same display area as a map displaying the user's location (as shown in FIG. 7). The SOS button, when pressed, activates an alarm. At step 126, the user selects the length of time that the SOS button has to be pressed before the alarm is activated.

When an alarm is activated/triggered, the digital application, in conjunction with the hardware of the user's electronic device 210, may record audio and/or video and/or stream video to one or more guardians. According to an embodiment, the user, at step 128, selects whether video recording and/or video streaming will be activated in the event that an alarm is activated.

According to an embodiment, the digital application, at step 130, stores a history of one or more actions performed by the user using the digital application. According to an embodiment, the history includes the date and time of each action. According to an embodiment, the history may be stored on the user's electronic device 210, the guardian's electronic device 224, a remote sever 228, and/or any other suitable location.

At step 132, an alarm is triggered and the one or more guardians are notified. The alarm may be triggered via any of the methods described above and/or through any other suitable method, while maintaining the spirit of the present invention.

According to an embodiment, at step 134, upon activating the alarm, audio and/or video is automatically recorded. This audio and/or video is then sent to the user's electronic device 210 and the electronic device 224 of one or more guardians. This enables the audio and/or video to have a backup in the event that the user's electronic device is lost, damaged, or destroyed. According to an embodiment, the user's electronic device 210 and the guardian's electronic device 224 include a transceiver for sending and receiving data.

According to an embodiment, at step 136, when the recording ends, one or more copies of the recording are sent to one or more remote servers 228 and to electronic devices 224 of one or more guardians. According to an embodiment, the digital application archives the recordings in the memory 214 of the user's electronic device 210, the guardian's electronic device 224, one or more remote servers 228, and/or any other suitable location.

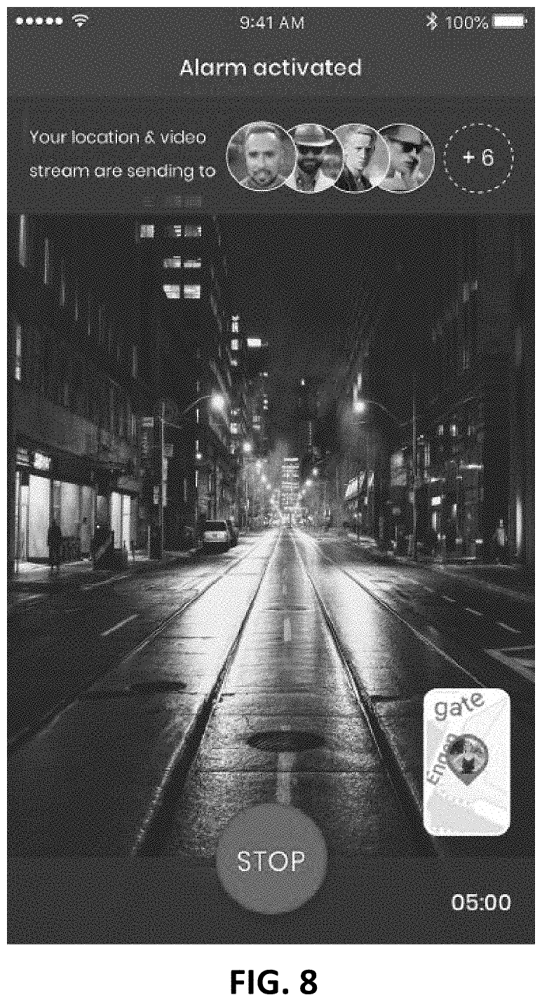

According to an embodiment, upon activating the alarm, at step 138, the digital application automatically opens on an electronic device 224 of one or more guardians. Once the digital application is open, at step 140, video and/or audio is live streamed to the electronic devices of the one or more guardians. According to an embodiment, at step 142, upon activating the alarm, the guardians are sent the user's location. According to an embodiment, the user is shown, using the graphical user interface 216, who the location and video is being sent to. For example, as shown in FIG. 8, the digital application displays to the user: “Your location & video stream are sending to”, followed by identifiers of the individual the location and video stream are being sent to. According to an embodiment, as shown in FIG. 8, there may be a stop button which enables the user to end the alarm.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present ivention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention.

Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RCS), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of_beverages, current_beverage_temperature, current_ambient_temperature, and/or the like. A Parameter table may include fields including the foregoing fields, or additional ones such as cool_start_time, cool_preset, cooling_rate, and/or the like. A Cool Routines table may include a plurality of cooling sequences may include fields such as, but not limited to: sequence_type, sequence_id, flow_rate, avg_water-temp, cooling_time, pump_setting, pump_speed, pump_pressure, power_level, temperature_sensor_id_number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method for alerting one or more third party individuals that a first user has activated an alarm, comprising:
creating a profile for the first user with a digital application, using a graphical user interface coupled to a first electronic device;
designating a method for triggering the alarm;
triggering the alarm;
notifying one or more second users on one or more second electronic devices that the alarm has been triggered;
recording environmental data using one or more sensors coupled to the first electronic device; and
sending the recording environmental data to the one or more second electronic devices.

2. The method as recited in claim 1, further comprising selecting the one or more second users using the graphical user interface.

3. The method as recited in claim 1, wherein the one or more sensors are selected from the group consisting of: a microphone; and a camera.

4. The method as recited in claim 3, wherein the environmental data includes one or more audio recordings.

5. The method as recited in claim 3, wherein the environmental data includes one or more video recordings.

6. The method as recited in claim 3, further comprising:
when the alarm is triggered, sending a live video stream from the first electronic device to the one or more second electronic devices.

7. The method as recited in claim 1, further comprising:
determining a location of the first electronic device.

8. The method as recited in claim 7, further comprising:
when the alarm is triggered, sending the location of the first electronic device to the one or more second electronic devices.

9. The method as recited in claim 1, wherein the first electronic device is a smart phone.

10. The method as recited in claim 1, further comprising:
sending the recorded environmental data to one or more remote servers.

11. A system for alerting one or more third party individuals that a first user has activated an alarm, comprising:
a first electronic device, including:
a memory configured to store a digital application;
a processor configured to run the digital application;
a graphical user interface configured to:
enable the first user to create a profile with the digital application;
designate a method for triggering the alarm; and
trigger the alarm;
one or more sensors coupled configured to record environmental data; and
a transceiver configured to:
notify one or more second users on one or more second electronic devices that the alarm has been triggered; and
send the recording environmental data to the one or more second electronic devices; and
the one or more second electronic devices.

12. The system as recited in claim 11, wherein the graphical user interface is further configured to enable the first user to select the one or more second users.

13. The system as recited in claim 11, wherein the one or more sensors are selected from the group consisting of: a microphone; and a camera.

14. The system as recited in claim 13, wherein the environmental data includes one or more audio recordings.

15. The system as recited in claim 13, wherein the environmental data includes one or more video recordings.

16. The system as recited in claim 13, wherein the transceiver is further configured to, when the alarm is triggered, send a live video stream from the first electronic device to the one or more second electronic devices.

17. The system as recited in claim 11, wherein the processor is further configured to determine a location of the first electronic device.

18. The system as recited in claim 17, wherein the transceiver is further configured to, when the alarm is triggered, send the location of the first electronic device to the one or more second electronic devices.

19. The system as recited in claim 11, wherein the first electronic device is a smart phone.

20. The method as recited in claim 1, further comprising one or more remote servers, and
wherein the transceiver is further configured to send the recorded environmental data to the one or more remote servers.
